(19) United States
(12) Patent Application Publication
(10) Pub. No.: US 2021/0261884 A1
(43) Pub. Date: Aug. 26, 2021

(54) DETERGENT COMPOSITION

(71) Applicant: Conopco. Inc,, d/b/a UNILEVER, Englewood Cliffs, NJ (US)

(72) Inventors: Stephen Norman BATCHELOR, Chester (GB); Neil Stephen BURNHAM, Liverpool (GB)

(73) Assignee: Conopco. Inc,, d/b/a UNILEVER, Englewood Cliffs, NJ (US)

(21) Appl. No.: 17/275,897

(22) PCT Filed: Sep. 12, 2019
(86) PCT No.: PCT/EP2019/074397

§ 371 Date: Mar. 12, 2021

(30) Foreign Application Priority Data
Sep. 18, 2018 (EP) 18195232.6

(51) Int. Cl. C11D 3/20; C11D 11/00; C11D 1/835; C11D 1/83; C11D 3/386

(52) U.S. Cl. CPC C11D 3/2093; C11D 11/0017; C11D 1/8355; C11D 1/72; C11D 3/38627; C11D 3/38645; C11D 3/38618; C11D 1/8305

(57) ABSTRACT

The present invention concerns a detergent composition, comprising: a) from 2 to 95 wt. %, preferably from 2 to 50 wt. %, more preferably from 2 to 40 wt. % of an organic acid derivative of mono- and di-glycerides of the form:— (I) wherein one or two, of R₁, R₂ and R₃ are independently selected from an acyl group of the formula R₄CO—; where R4 is a linear or branched, saturated or mon-unsaturated C₉ to C₂₁ alkyl chain; wherein one or two, of R1, R2 and R3 is selected from an organic acid of generic formulation (HOOC)ₙXCO—; wherein X is saturated or monounsaturated organic group containing 1 to 6 carbon atoms and n=1 to 3; wherein one or none of R₁, R₂ and R₃ is selected from H; and, b) from 0.5 to 25 wt. %, preferably from 1 to 20 wt. %, more preferably from 1 to 10 wt. % of non-ionic surfactant; and to domestic method of treatment of a textile using said composition.

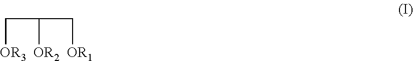

### FIELD OF INVENTION

The present invention concerns a detergent composition. More particularly a detergent composition comprising a surfactant which is an organic acid derivative of mono- and di-glycerides, and non-ionic surfactant.

### BACKGROUND OF THE INVENTION

Organic acid ester derivatives of mono- and di-glycerides are surfactants used in food processing, for example in bakery to improve bread quality or in chocolate to prevent blooming. They are produced from animal and plant based ingredients.

It would be desirable to include organic acid derivative of mono- and di-glycerides in detergent compositions, preferably laundry detergent compositions, however a problem with these surfactants is that their detergent performance needs to be improved.

It is desired to have detergent compositions, preferably laundry detergent compositions containing organic acid derivative of mono- and di-glycerides with improved cleaning performance.

### SUMMARY OF THE INVENTION

The invention relates in a first aspect to a detergent composition comprising:
a) from 2 to 95 wt. %, preferably from 2 to 50 wt. %, more preferably from 2 to 40 wt. %, most preferably from 2.5 to 40 wt. % of an organic acid derivative of mono- and di-glycerides of the form:—

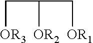

wherein one or two, preferably one, of R₁, R₂ and R₃ are independently selected from an acyl group of the formula R₄CO— where R₄ is a linear or branched, saturated or mon-unsaturated C₉ to C₂₁ alkyl chain, preferably C₁₅ to C₂₁ linear alkyl chain, most preferably a saturated or mon-unsaturated C₁₅ to C₁₇ linear alkyl chain;
wherein one or two, preferably one, of R₁, R₂ and R₃ is selected from an organic acid of generic formulation (HOOC)ₙXCO— where in X is saturated or monounsaturated organic group containing 1 to 6 carbon atoms and n=1 to 3;
wherein one or none of R₁, R₂ and R₃ is selected from H, preferably one of R₁, R₂ and R₃ is selected from H;

b) from 0.5 to 25 wt. %, preferably from 1 to 20 wt. %, more preferably from 1 to 10 wt. % of non-ionic surfactant.

In a second aspect the present invention provides a domestic method of treating a textile, the method comprising the steps of:—
a) treating a textile with an aqueous solution of 0.5 to 20 g/L, more preferably 1 to 10 g/L of the detergent composition according to the first aspect of the invention;
b) optionally rinsing and drying the textile.

Preferably wherein (HOOC)ₙXCO is selected from citric acid, malic acid, tartaric acid, monoacetyl and diacetyl tartaric acid, succinic acid, oxalic acid, maleic acid, fumaric acid, malonic acid, more preferably citric acid, lactic acid, tartaric acid, monoacetyl and diacetyl tartaric acid, where an OH is lost from an acid group to form the ester.

Preferably the organic acid derivative of mono- and di-glycerides are selected from:— citric acid esters of mono- and diglycerides (citrem); tartaric acid esters of mono- and di-glycerides (tatem); diacetyltartaric acid esters of mono- and diglycerides (datem); and mixed acetic-, tartaric- and di-acetylated tartaric acid esters of mono- and di-glycerides (MATEM); most preferably the organic acid derivative of mono- and di-glycerides are selected from:— citric acid esters of mono- and diglycerides (citrem).

Preferably the non-ionic surfactant is selected from saturated and mono-unsaturated aliphatic alcohol ethoxylates and saturated and mono-unsaturated fatty acid sugar esters.

Most preferably the non-ionic surfactant is saturated and mono-unsaturated aliphatic alcohol ethoxylates, preferably selected from C₁₂ to C₂₀ primary linear alcohol ethoxylates with an average of from 5 to 30 ethoxylates, more preferably 016 to 018 with an average of from 10 to 25 ethoxylates.

Preferably the weight fraction of organic acid derivative of mono- and di-glycerides to non-ionic surfactant is from 10:1 to 1:10, preferably from 5:1 to 1:5.

Preferably the detergent composition is a laundry detergent composition.

Preferably the laundry detergent composition comprises an anionic surfactant selected from C₁₂ to C₁₈ alkyl ether carboxylate and water-soluble alkali metal salts of organic sulphates, ether sulphates and sulphonates having alkyl radicals containing from about 8 to about 22 carbon atoms.

Preferably the laundry detergent composition comprises one or more enzymes from the group: lipid esterases, proteases, amylases and cellulases.

Preferably the composition is a liquid or a liquid unit dose composition.

### DETAILED DESCRIPTION OF THE INVENTION

The formulation may be in any form for example a liquid, solid, powder, liquid unit dose.

Preferably the composition is a liquid or a liquid unit dose composition.

The formulation when dissolved in demineralised water preferably has a pH of 4 to 8, more preferably 6.5 to 7.5, most preferably 7.

### Organic Acid Derivative of Mono and Diglycerides

In the text, organic acid derivative of mono- and di-glycerides will be referred to as glyceride carboxylates.

The organic acid derivative of mono- and di-glycerides are of the form:—

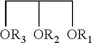

wherein one or two, preferably one, of R₁, R₂ and R₃ are independently selected from an acyl group of the formula R₄CO— where R₄ is a linear or branched, saturated or mon-unsaturated C₉ to C₂₁ alkyl chain, preferably C₁₅ to C₂₁ linear alkyl chain, most preferably a saturated or mon-unsaturated C₁₅ to C₁₇ linear alkyl chain;
wherein one or two, preferably one, of R₁, R₂ and R₃ is selected from an organic acid of generic formulation (HOOC)ₙXCO— where in X is saturated or monounsaturated organic group containing 1 to 6 carbon atoms and n=1 to 3;
wherein one or none of R₁, R₂ and R₃ is selected from H, preferably one of R₁, R₂ and R₃ is selected from H.

Preferably (HOOC)ₙXCO is selected from citric acid, malic acid, tartaric acid, monoacetyl and diacetyl tartaric acid, succinic acid, oxalic acid, maleic acid, fumaric acid, malonic acid, more preferably citric acid, lactic acid, tartaric acid, monoacetyl and diacetyl tartaric acid, where an OH is lost from an acid group to form the ester.

Weights of the organic acid derivative of mono- and di-glycerides are for the protonated form.

Glyceride carboxylate may be synthesised by the esterification of mono and diglycerides with organic acids. Mono and diglycerides may be produced by fat glycerolysis (200° C., Basic catalyst). The monoglycerides may be separated by distillation under high vacuum. Mono and diglycerides may also be produced by lipid esterase catalysed hydrolysis of the fat. The organic acid is may then added by an esterification reaction, or reaction with the anhydride of the organic acid where the structure permits.

The properties and synthesis of glyceride carboxylates are discussed in Hasenhuettl, G. L and Hartel, R. W. (Eds) Food Emulsifiers and Their Application. 2008 (Springer) and in Whitehurst, R. J. (Ed) Emulsifiers in Food Technology 2008 (Wiley-VCH) and in the 2^{nd} edition of this book edited by V. Norn 2015 (Wiley-Blackwell).

Preferred organic acid derivative of mono- and di-glycerides are selected from:—

E472c Citric acid esters of mono- and diglycerides (citrem);

E472d Tartaric acid esters of mono- and diglycerides (tatem);

E472e Diacetyltartaric acid esters of mono- and diglycerides (datem); and,

E472f Mixed acetic-, tartaric- and diacetylated tartaric acid esters of mono- and diglycerides (MATEM).

More preferred organic acid derivative of mono- and di-glycerides are selected from:—

E472c Citric acid esters of mono- and diglycerides (citrem);

E472d Tartaric acid esters of mono- and diglycerides (tatem); and,

E472e Diacetyltartaric acid esters of mono- and diglycerides (datem).

Where is the E number is the codes for substances that are permitted to be used as food additives for use within the European Union.

E472c Citric acid esters of mono- and diglycerides (citrem) is most preferred.

Preferably the glyceride carboxylate is an acid ester of a mono glyceride. Preferably the mono glyceride is obtained from plants, preferably from rape seed, sunflower, maze, soy, peanut, cottonseed, olive oil, tall oil.

The glyceride carboxylate may be in salt form or acid form, typically in the form of a water-soluble sodium, potassium, ammonium, magnesium or mono-, di- or tri-C₂-C₃ alkanolammonium salt, with the sodium cation being the usual one chosen.

Preferably the glyceride carboxylate has predominately saturate and mono-unsaturated C₁₈ linear alkyl chains, most preferably the weight fraction of (C₁₈ glyceride carboxylate)/(C₁₆ glyceride carboxylate) is preferably from 2 to 400, more preferably 8 to 200 where the weight of glyceride carboxylate is for the protonated form.

Examples of preferred structures are

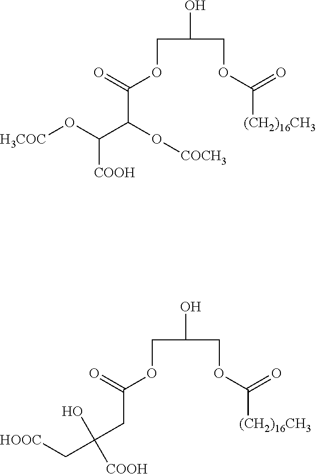

These are saturated C₁₈ glyceride carboxylates.

Preferably the glyceride carboxylates contain less than 1 wt. % of material with polyunsaturated alkyl chains, more preferably less than 0.5 wt. %, most preferably less than 0.1 wt. %. This may be achieved by hydrogenation of the oil.

Glyceride carboxylates are available from Danisco, Palsgaard, and Acatris.

The organic acid derivative of mono- and di-glycerides is present at a level of from 2 to 95 wt. %, preferably from 2 to 50 wt. %, more preferably from 2 to 40 wt. %. Other preferred levels include 2.5 wt. % to 95 wt. % preferably from 2.5 to 50 wt. %, more preferably from 2.5 to 40 wt. %. Other preferred levels include 3 wt. % to 95 wt. % preferably from 3 to 50 wt. %, more preferably from 3 to 40 wt. %.

Glyceride carboxylate are often supplied with unsubstituted mono and diglycerides, preferably the weight ratio of (glyceride carboxylate)/(unsubstituted mono and diglycerides) is greater than 1, more preferably greater than 2, most preferably greater than 4. Preferably the unsubstituted mono and diglycerides are predominately monoglycerides by weight.

### Non-Ionic Surfactant

Non-ionic surfactants are preferably selected from saturated and mono-unsaturated aliphatic alcohol ethoxylates and saturated and mono-unsaturated fatty acid sugar esters.

Sugar esters are discussed in in Whitehurst, R. J. (Ed) Emulsifiers in Food Technology 2008 (Wiley-VCH).

Aliphatic alcohol ethoxylates for use in the invention may suitably be selected from C₈ to C₁₈ primary or secondary linear or branched alcohol ethoxylates with an average of from 2 to 40 moles of ethylene oxide per mole of alcohol.

Preferred aliphatic alcohol ethoxylates for use in the invention may be selected from C₁₂ to C₂₀ primary linear alcohol ethoxylates with an average of from 5 to 30 ethoxylates, more preferably C₁₆ to C₁₈ with an average of from 10 to 25 ethoxylates. Preferably the alkyl chain is mono-unsaturated.

Mixtures of any of the above described materials may also be used.

The total amount of nonionic surfactants (b) in a composition of the invention ranges from 0.5 to 25 wt. %, preferably from 1 to 20 wt. %, more preferably from 1 to 10 wt. %, most preferably from 1 to 3.5 wt. % based on the total weight of the composition.

Preferably the weight fraction of organic acid derivative of mono- and di-glycerides to non-ionic surfactant is from 10:1 to 1:10, preferably from 5:1 to 1:5.

### Further Ingredients

The formulation may contain further ingredients.

### Further Surfactant

Surfactants are discussed in the Surfactant Science Series published by CRC press, series editor: Arthur T. Hubbard.

Further surfactant may be present at a preferable level of from 0.5 to 40 wt. %, more preferably from 1 to 30 wt. %.

The formulation may comprise anionic detergent compounds which preferably are 012 to 018 alkyl ether carboxylate and water-soluble alkali metal salts of organic sulphates, ether sulphates and sulphonates having alkyl radicals containing from about 8 to about 22 carbon atoms, the term alkyl being used to include the alkyl portion of higher alkyl radicals.

Examples of suitable synthetic anionic detergent compounds are sodium and potassium alkyl sulphates, especially those obtained by sulphating higher C₁₂ to C₁₈ alcohols, sodium and potassium alkyl C₉ to C₂₉ benzene sulphonates, particularly sodium linear secondary alkyl C₁₀ to C₁₅ benzene sulphonates, alkyl (preferably methyl) ester sulphonates, and mixtures thereof.

Preferably these are present at lower levels than the glyceride carboxylate, preferably the weight fraction of further anionic surfactant/glyceride carboxylate is from 0 to 0.4, preferably 0 to 0.1

Preferably the surfactants used are saturated or mono-unsaturated.

To prevent oxidation of the formulation an anti-oxidant may be present in the formulation.

### Builders or Complexing Agents

The composition may comprise a builder.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are well known representatives thereof, e.g. zeolite A, zeolite B (also known as zeolite P), zeolite C, zeolite X, zeolite Y and also the zeolite P-type as described in EP-A-0,384,070.

The composition may also contain 0-65 wt. % of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (carbonate (including bicarbonate and sesquicarbonate) are preferred builders, with carbonates being particularly preferred.

The composition may contain as builder a crystalline aluminosilicate, preferably an alkali metal aluminosilicate, more preferably a sodium aluminosilicate. This is typically present at a level of less than 15 wt. %, preferably less than 12.5 wt. %, more preferably less than 10 wt. %.

Aluminosilicates are materials having the general formula:

0.8-1.5 M₂O.Al₂O₃. 0.8-6 SiO₂,

where M is a monovalent cation, preferably sodium.

These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

More preferably the laundry detergent formulation is a non-phosphate built laundry detergent formulation, i.e., contains less than 1 wt. % of phosphate. Most preferably the laundry detergent formulation is not built i.e. contain less than 1 wt. % of builder.

If the detergent composition is an aqueous liquid laundry detergent it is preferred that mono propylene glycol is present at a level from 1 to 30 wt. %, most preferably 2 to 18 wt. %, to provide the formulation with appropriate, pourable viscosity.

### Fluorescent Agent

The composition preferably comprises a fluorescent agent (optical brightener).

Fluorescent agents are well known and many such fluorescent agents are available commercially. Usually, these fluorescent agents are supplied and used in the form of their alkali metal salts, for example, the sodium salts.

The total amount of the fluorescent agent or agents used in the composition is generally from 0.0001 to 0.5 wt. %, preferably 0.005 to 2 wt. %, more preferably 0.01 to 0.1 wt. %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN.

Preferred fluorescers are fluorescers with CAS-No 3426-43-5; CAS-No 35632-99-6; CAS-No 24565-13-7; CAS-No 12224-16-7; CAS-No 13863-31-5; CAS-No 4193-55-9; CAS-No 16090-02-1; CAS-No 133-66-4; CAS-No 68444-86-0; CAS-No 27344-41-8.

Most preferred fluorescers are: sodium 2 (4-styryl-3-sulfophenyl)-2H-napthol[1,2-d]triazole, disodium 4,4′-bis{[(4-anilino-6-(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]amino} stilbene-2-2′ disulphonate, and disodium 4,4′-bis(2-sulphostyryl)biphenyl.

The formulation may contain shading dyes, such as acid violet 50, Direct Violet 9 and Disperse Violet 28. Shading dyes are preferably present at 0.0001 to 0.1 wt. %.

### Perfume

The composition preferably comprises a perfume. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Preferably the perfume comprises at least one note (compound) from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester; amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

Useful components of the perfume include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Perfume and Flavour Chemicals by S. Arctander 1969, Montclair, N.J. (USA).

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt. % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

The International Fragrance Association has published a list of fragrance ingredients (perfumes) in 2011. (http://www.ifraorg.org/en-us/ingredients#.U7Z4hPldWzk) The Research Institute for Fragrance Materials provides a database of perfumes (fragrances) with safety information.

Perfume top note may be used to cue the whiteness and brightness benefit of the invention. Some or all of the perfume may be encapsulated, typical perfume components which it is advantageous to encapsulate, include those with a relatively low boiling point, preferably those with a boiling point of less than 300, preferably 100-250 Celsius. It is also advantageous to encapsulate perfume components which have a low C Log P (ie. those which will have a greater tendency to be partitioned into water), preferably with a C Log P of less than 3.0. These materials, of relatively low boiling point and relatively low C Log P have been called the “delayed blooming” perfume ingredients and include one or more of the following materials: allyl caproate, amyl acetate, amyl propionate, anisic aldehyde, anisole, benzaldehyde, benzyl acetate, benzyl acetone, benzyl alcohol, benzyl formate, benzyl iso valerate, benzyl propionate, beta gamma hexenol, camphor gum, laevo-carvone, d-carvone, cinnamic alcohol, cinamyl formate, cis-jasmone, cis-3-hexenyl acetate, cuminic alcohol, cyclal c, dimethyl benzyl carbinol, dimethyl benzyl carbinol acetate, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, flor acetate (tricyclo decenyl acetate), frutene (tricycico decenyl propionate), geraniol, hexenol, hexenyl acetate, hexyl acetate, hexyl formate, hydratropic alcohol, hydroxycitronellal, indone, isoamyl alcohol, iso menthone, isopulegyl acetate, isoquinolone, ligustral, linalool, linalool oxide, linalyl formate, menthone, menthyl acetphenone, methyl amyl ketone, methyl anthranilate, methyl benzoate, methyl benyl acetate, methyl eugenol, methyl heptenone, methyl heptine carbonate, methyl heptyl ketone, methyl hexyl ketone, methyl phenyl carbinyl acetate, methyl salicylate, methyl-n-methyl anthranilate, nerol, octalactone, octyl alcohol, p-cresol, p-cresol methyl ether, p-methoxy acetophenone, p-methyl acetophenone, phenoxy ethanol, phenyl acetaldehyde, phenyl ethyl acetate, phenyl ethyl alcohol, phenyl ethyl dimethyl carbinol, prenyl acetate, propyl bornate, pulegone, rose oxide, safrole, 4-terpinenol, alpha-terpinenol, and/or viridine. It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as Clary Sage, Eucalyptus, Geranium, Lavender, Mace Extract, Neroli, Nutmeg, Spearmint, Sweet Violet Leaf and Valerian.

It is preferred that the laundry treatment composition does not contain a peroxygen bleach, e.g., sodium percarbonate, sodium perborate, and peracid.

### Polymers

The composition may comprise one or more further polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

Where alkyl groups are sufficiently long to form branched or cyclic chains, the alkyl groups encompass branched, cyclic and linear alkyl chains. The alkyl groups are preferably linear or branched, most preferably linear.

Enzymes, such as lipid esterases, proteases, amylases and cellulases may be present in the formulation.

The detergent compositions optionally include one or more laundry adjunct ingredients.

The term “adjunct ingredient” includes: perfumes, dispersing agents, stabilizers, pH control agents, metal ion control agents, colorants, brighteners, dyes, odour control agent, pro-perfumes, cyclodextrin, perfume, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mould control agents, mildew control agents, antiviral agents, antimicrobials, drying agents, stain resistance agents, soil release agents, malodour control agents, fabric refreshing agents, chlorine bleach odour control agents, dye fixatives, dye transfer inhibitors, shading dyes, colour maintenance agents, colour restoration, rejuvenation agents, anti-fading agents, whiteness enhancers, anti-abrasion agents, wear resistance agents, fabric integrity agents, anti-wear agents, and rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, and combinations thereof. If present, such adjuncts can be used at a level of from 0.1% to 5% by weight of the composition

The indefinite article “a” or “an” and its corresponding definite article “the” as used herein means at least one, or one or more, unless specified otherwise.

The invention will be further described with the following non-limiting examples.

### Examples

Surfactants were dissolved in 24 French hard water to give 0.15 g/L solution, 800 ml of the solution was used to wash four 5×5 cm EMPA 117 stain monitor (blood/milk/ink stain on polycotton) in a tergotometer set at 200 rpm. The wash is equivalent to dosing 1.5 g/L of a laundry treatment composition containing 10 wt. % of surfactant or 15 g/L of a laundry treatment composition containing 1 wt. % of the surfactant. The wash was a 60 minute wash at a temperature of 30° C.

Once the wash had been completed the monitors were rinsed once in 400 ml clean water, removed dried and the colour measured on a reflectometer and expressed as the CIE L*a*b* values.

Stain removal was calculated as the ΔL* value:

ΔL*=L*(after wash)−L*(before wash)

Higher ΔL* value equate to better cleaning.

| Surfactant system | ΔL* | 95% |
|---|---|---|
| Citrem | 11.3 | 1.2 |
| Citrem + C₁₂₋₁₅(EO)₇ | 13.4 | 0.3 |
| Citrem + C₁₈(EO)₁₀ | 14.4 | 0.5 |
| Datem | 12.5 | 0.5 |
| Datem + C₁₂₋₁₅(EO)₇ | 14.2 | 0.4 |
| Datem + C₁₈(EO)₁₀ | 15.3 | 0.4 |

C₁₂₋₁₅(EO)₇ is an alcohol ethoxylate with a linear alkyl chain of 12 to 15 carbons and 7 mole equivalents of ethoxylate.

C₁₈(EO)₁₀ is an alcohol ethoxylate with a linear mono-unsaturated alkyl chain (oleic) of 18 carbons and 10 mole equivalents of ethoxylate.

Datem is the diacetyl tartaric acid ester of monoglycerides made from edible, fully hydrogenated rapeseed oil.

Citrem is the citric acid ester of mono and diglycerides, made from edible, fully hydrogenated rapeseed oil.

Rapeseed oil contains greater than 90% C18 fatty acids.

In the mixed system containing non-ionic the glyceride carboxylate:non-ionic ratio was 2:1, e.g. 0.1 g/L citrem and 0.05 g/L C₁₈(EO)₁₀.

The non-ionic surfactants enhance the cleaning performance as shown by an increase in the ΔL* values. The C₁₈(EO)₁₀ is most effective.

1. A detergent composition, comprising:
a) from 2 to 95 wt. %, preferably from 2 to 50 wt. %, more preferably from 2 to 40 wt. %, most preferably from 2.5 wt. % to 40 wt. % of an organic acid derivative of mono- and di-glycerides of the form:— 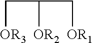
wherein one or two, of R₁, R₂ and R₃ are independently selected from an acyl group of the formula R₄CO—; where R₄ is a linear or branched, saturated or mon-unsaturated C₉ to C₂₁ alkyl chain;
wherein one or two, of R₁, R₂ and R₃ is selected from an organic acid of generic formulation (HOOC)ₙXCO—; wherein X is saturated or monounsaturated organic group containing 1 to 6 carbon atoms and n=1 to 3;
wherein one or none of R₁, R₂ and R₃ is selected from H; and,
b) from 0.5 to 25 wt. %, preferably from 1 to 20 wt. %, more preferably from 1 to 10 wt. % of non-ionic surfactant.

2. A detergent composition according to claim 1, wherein one of R₁, R₂ and R₃ are independently selected from an acyl group of the formula R₄CO— where R₄ is a linear or branched, saturated or mon-unsaturated C₉ to C₂₁ alkyl chain.

3. A detergent composition according to claim 1, wherein R₄ is a linear or branched, saturated or mon-unsaturated C₁₅ to C₂₁ linear alkyl chain, preferably a saturated or mon-unsaturated C₁₅ to C₁₇ linear alkyl chain.

4. A detergent composition according to claim 1, wherein one, of R₁, R₂ and R₃ is selected from an organic acid of generic formulation (HOOC)ₙXCO—; wherein X is saturated or monounsaturated organic group containing 1 to 6 carbon atoms and n=1 to 3.

5. A detergent composition according to claim 1, wherein (HOOC)ₙXCO is selected from citric acid, malic acid, tartaric acid, monoacetyl and diacetyl tartaric acid, succinic acid, oxalic acid, maleic acid, fumaric acid, malonic acid, more preferably citric acid, lactic acid, tartaric acid, monoacetyl and diacetyl tartaric acid, where an OH is lost from an acid group to form the ester.

6. A detergent composition according to claim 1, wherein one of R₁, R₂ and R₃ is selected from H.

7. A detergent composition according to claim 1, wherein the organic acid derivative of mono- and di-glycerides are selected from:— citric acid esters of mono- and diglycerides (citrem); tartaric acid esters of mono- and di-glycerides (tatem); diacetyltartaric acid esters of mono- and diglycerides (datem); and, mixed acetic-, tartaric- and di-acetylated tartaric acid esters of mono- and di-glycerides (MATEM);
preferably the organic acid derivative of mono- and di-glycerides are selected from:—
citric acid esters of mono- and diglycerides (citrem); tartaric acid esters of mono- and di-glycerides (tatem); and, diacetyltartaric acid esters of mono- and diglycerides (datem); most preferably the organic acid derivative of mono- and di-glycerides are selected from:— citric acid esters of mono- and diglycerides (citrem).

8. A detergent composition according to claim 1, wherein the non-ionic surfactant is selected from saturated and mono-unsaturated aliphatic alcohol ethoxylates and saturated and mono-unsaturated fatty acid sugar esters.

9. A detergent composition according to claim 8, wherein the non-ionic surfactant is saturated and mono-unsaturated aliphatic alcohol ethoxylates, preferably selected from C₁₂ to C₂₀ primary linear alcohol ethoxylates with an average of from 5 to 30 ethoxylates, more preferably C₁₆ to C₁₈ with an average of from 10 to 25 ethoxylates.

10. A detergent composition according to claim 1, wherein the weight fraction of organic acid derivative of mono- and di-glycerides to non-ionic surfactant is from 10:1 to 1:10, preferably from 5:1 to 1:5.

11. A detergent composition according to claim 1, wherein the detergent composition is a laundry detergent composition.

12. A laundry detergent composition according to claim 11, comprising an anionic surfactant selected from C₁₂ to C₁₈ alkyl ether carboxylate and water-soluble alkali metal salts of organic sulphates, ether sulphates and sulphonates having alkyl radicals containing from about 8 to about 22 carbon atoms.

13. A laundry detergent composition according to claim 11, comprising one or more enzymes from the group: lipid esterases, proteases, amylases and cellulases.

14. A laundry detergent composition according to claim 11, wherein the composition is a liquid or a liquid unit dose composition.

15. A domestic method of treating a textile, comprising the steps of:—
a) treating a textile with an aqueous solution of 0.5 to 20 g/L, more preferably 1 to 10 g/L of the detergent composition according to any one of claims 1 to 14;
b) optionally rinsing and drying the textile.
